(19) United States
(12) Patent Application Publication
(10) Pub. No.: US 2009/0047933 A1
(43) Pub. Date: Feb. 19, 2009

(54) Messaging network, system and method for an away user of a mobile communications device

(76) Inventor: Josh Spitzer, Wynnewood, PA (US)

Correspondence Address: Gibbons PC, 1700 Two Logan Square, 18th & Arch Streets, Philadelphia, PA, 19103-2769, US

(21) Appl. No.: 12/218,346

(22) Filed: Jul. 14, 2008

Related U.S. Application Data
(60) Provisional application No. 60/959,430, filed on Jul. 13, 2007.

(51) Int. Cl. H04L 12/58

(52) U.S. Cl. 455/412.1

(57) ABSTRACT

Multiple customized options for Voicemail and Text Message Response, and a method to receive voicemails and text messages for a mobile telecommunication device using an away message technique, are disclosed. Further, if the caller requires the ability to speak with the phone owner (“user”) while the user's away message is activated, the caller may dial a specific number followed by the pound key to bypass the system.

### CROSS-REFERENCE TO RELATED APPLICATIONS

This application claims priority to U.S. Provisional Patent Application No. 60/959,430, filed Jul. 13, 2007.

### BACKGROUND OF THE INVENTION

1. Field of the Invention

The present invention relates to phone calls and text messages, and more specifically relates to the providing of an “Away,” or busy, message to a caller calling a user who is unable to answer a mobile telecommunication device.

2. Description of the Background

Available methodologies of voice messaging for users unable to answer a cell phone typically include a standard voice message system made available by a communications hub for calls made to telephones that do not accept or receive the call, and multi-option voice messages resident on the memory of the cellular phone which may be optionally made available by a user of the phone based on receipt of the call by the user. However, in the above referenced typically available embodiments, if the cellular phone that the call is directed to is off, only the single standard voicemail available at the hub will be played to the caller, and only in the event that the cellular phone is on when the call is received, and the user interacts during receipt of the call to select ones of multiple voicemails in real time, can the multi-operation voice messages be selected for play to the caller.

Thus, the need exists for a cellular phone voice messaging system that, based on the number of the calling party or any of a myriad of other available information items related to the caller or the user, will allow for the play to the calling party from the hub of any one of a number of selectable voice messaging options including, when the called cellular telephone is in the “off” position.

### SUMMARY OF THE INVENTION

Multiple customized options for Voicemail and Text Message Response, and a method to receive voicemails and text messages for a mobile telecommunication device using an away message technique, are disclosed. Further, if the caller requires the ability to speak with the phone owner (“user”) while the user's away message is activated, the caller may dial a specific number followed by the pound key to bypass the system.

More specifically, the present invention includes multiple temporary, automated and customized responses to incoming phone calls and text messages. The phone owner (“user”) will be able to record multiple voicemail messages in advance. When the phone cannot be answered, the user can choose which voicemail message will play for incoming calls. As the messages can be customized, it is possible for the user to say his/her location, reason for not answering the phone personally, when they will be available, etc. Similarly, incoming text messages that cannot be read immediately will be met with a variety of personalized text responses chosen by the user. This user text response would automatically be sent to the sender of the text message. This text response could give information about the user's whereabouts, duration of time unable to personally read text messages, etc. Although this method would allow the user to utilize a temporary away message for both incoming phone calls and text messages, the user could specify which, if any, features that they would like to turn off.

### DESCRIPTION OF THE DRAWINGS

For the present invention to be clearly understood and readily practiced, the present invention will be described in conjunction with the following figures, wherein:

FIG. 1 is a diagram of the home screen for a mobile phone device. The purpose of this diagram is to depict where the icon could lie in relation to other, already used, application icons;

FIG. 2 is a diagram of an exemplary Recordings menu created for the Away Message feature. Using the touch screen, or the arrow keys, the user is able to scroll through the pre-recorded and personalized messages displayed on the screen in order to choose which option they would like to use. On the bottom left-hand-side of the screen, there is a button entitled “new” that allows the user to create a new recording and text message (for the away message);

FIG. 3 is a diagram that displays an opening call screen. This opening display allows the user to make calls or access a list of shortcuts. On the bottom right there is a new addition to this list. The new Away Message shortcut is situated at the bottom right-hand-side of the screen. When the user clicks on this icon, they may be brought to FIG. 2;

FIG. 4 is a diagram of a screen for checking one's voicemail. This screen will stay the same for the user as the user retrieves voicemail in the same fashion. This screen will appear following the users decision to check his or her voicemail in FIG. 5;

FIG. 5 is a diagram of the voicemail indicator screen. Each user may receive this message after he or she selects the option, “I'm Back,” from FIG. 6. Using this screen, the user will be able to see when the voicemails were left, and be given the choice whether he or she would like to listen to the messages at that particular time or at a later time;

FIG. 6 is a diagram depicting what the actual away message may look like. Using the message that the user chose to use (FIG. 2), the user has the option whether they would like to use it for text messages, calls, or both (FIG. 7). Either way, the screen may display the Auto Answer message. The screen will also alert the user how many missed calls, voicemails, and text messages have been received. When the user decides that he or she would like to resume normal usage of the mobile device, he can click the “I'm Back” icon;

FIG. 7 is a diagram depicting two options for using the Away Message feature. The user is able to use this feature for auto-replying to text messages, calls, or both simultaneously. Once the user has chosen his or her preferences, he or she may then click ok to finalize these options. If he or she mistakably hits the preference screen, they may hit the cancel button;

FIG. 8 is a chart depicting the exemplary steps to set an away message, the steps required to change the preferences of the away message, and the steps required to create a new personalized away message;

FIG. 9 is a chart depicting the steps that the away message method might use; and

FIG. 10 illustrates a Network having therein a user mobile device implementing the present invention.

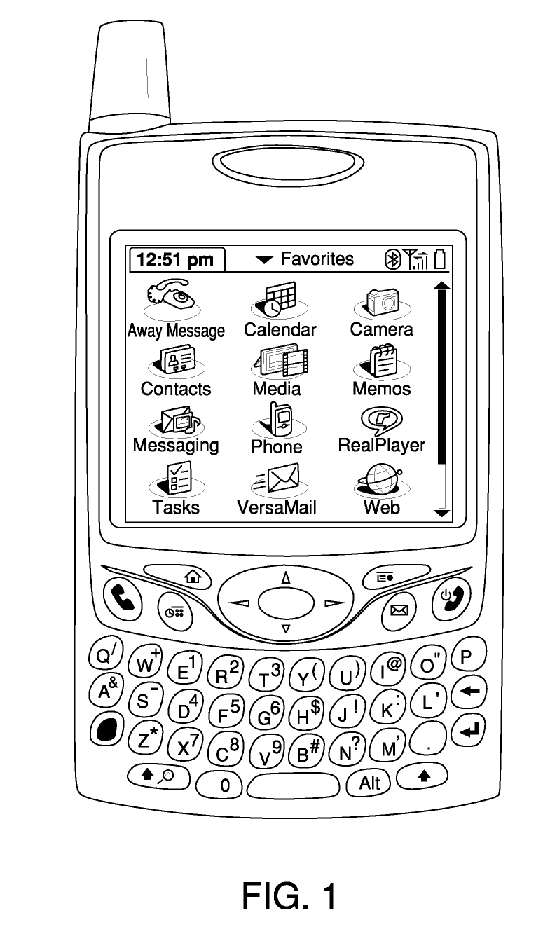

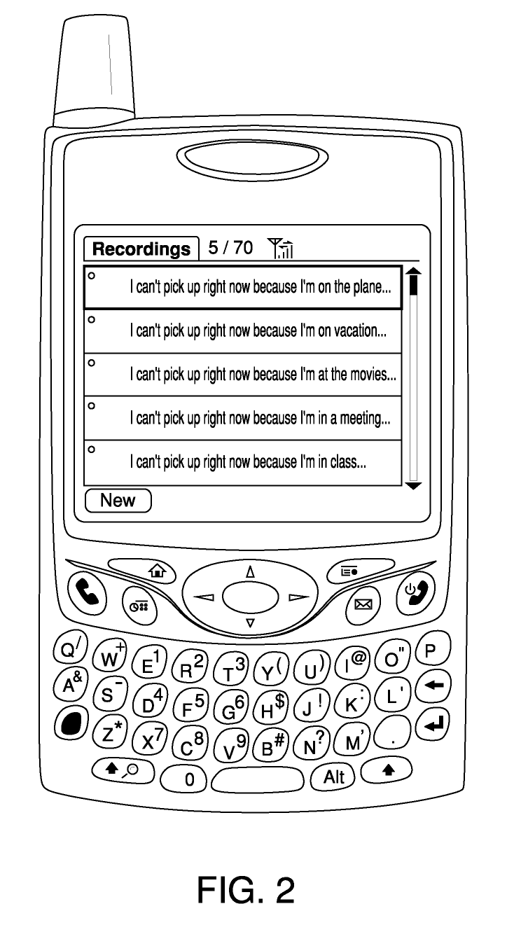

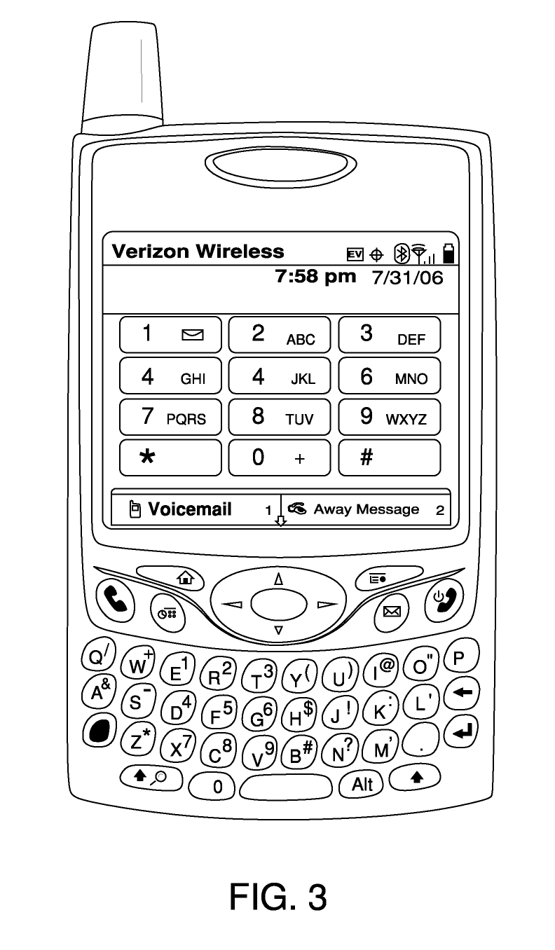

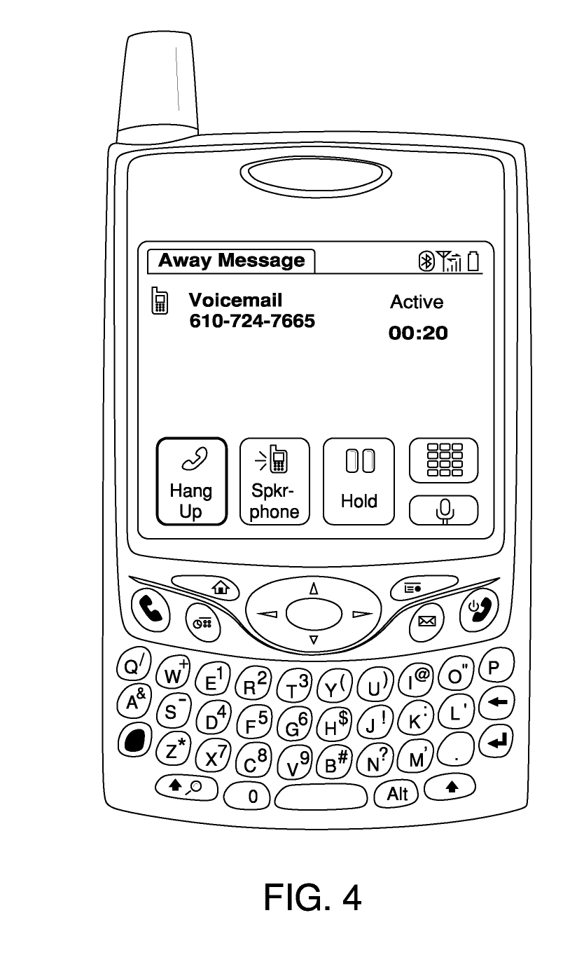

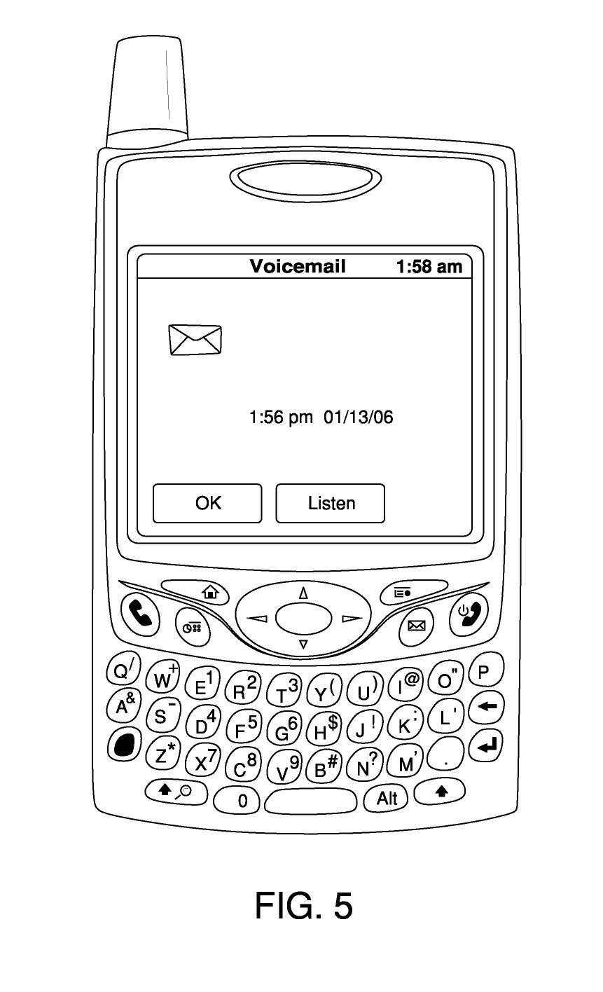

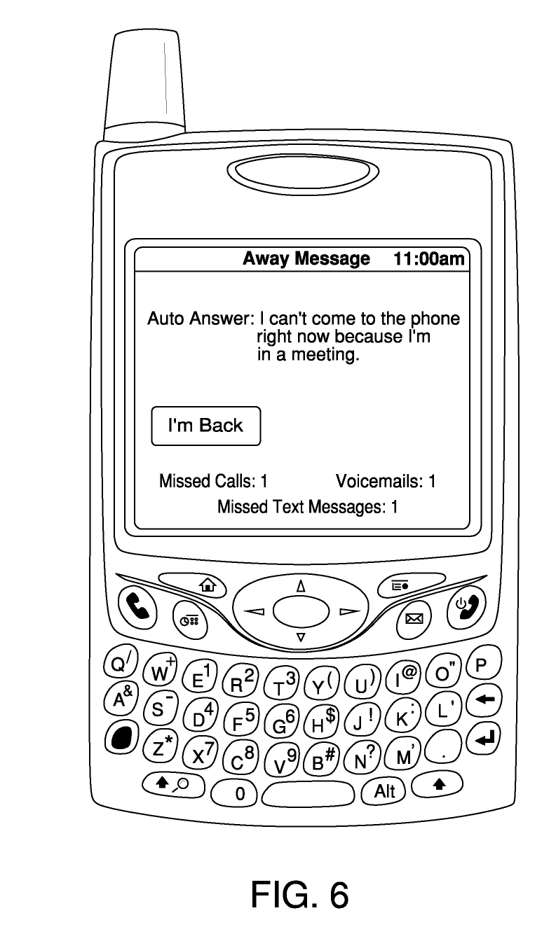

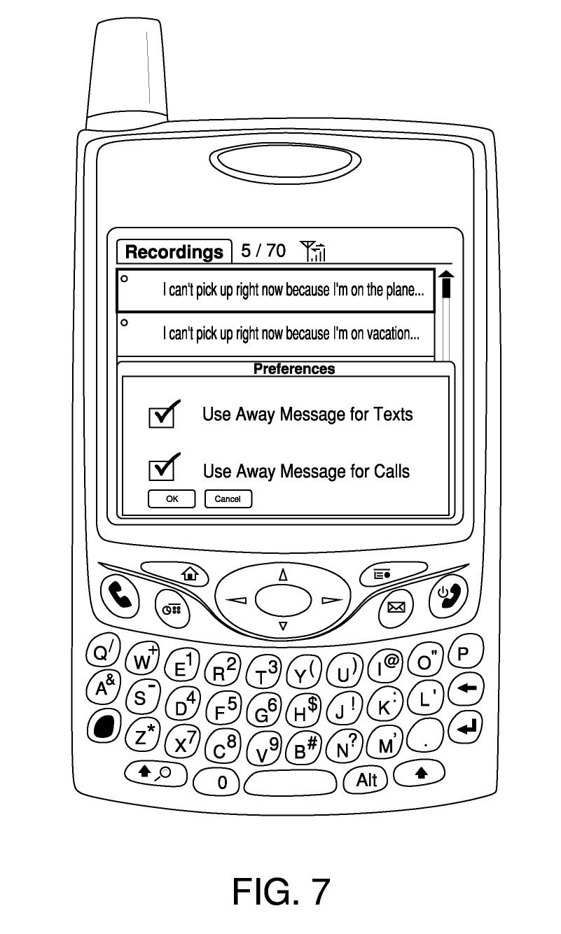

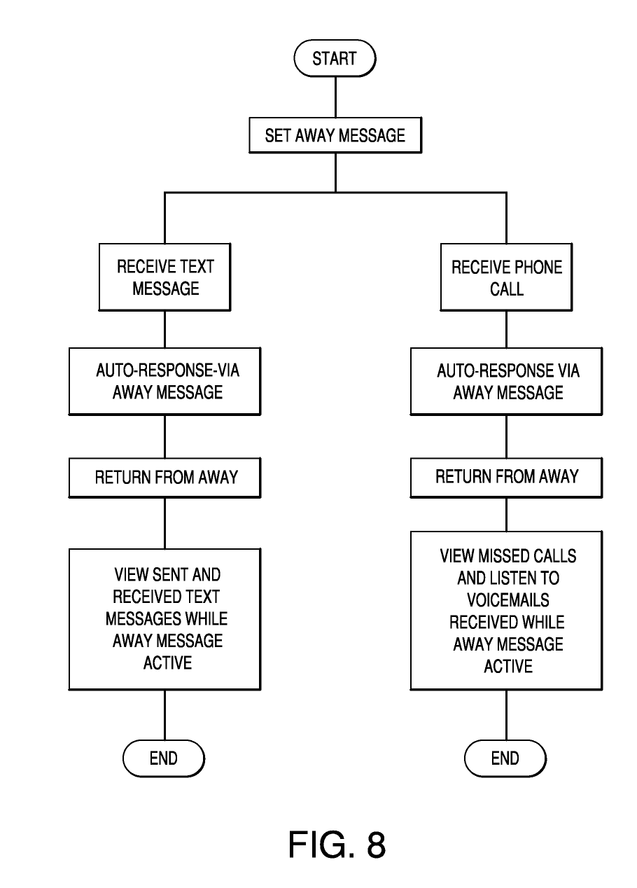

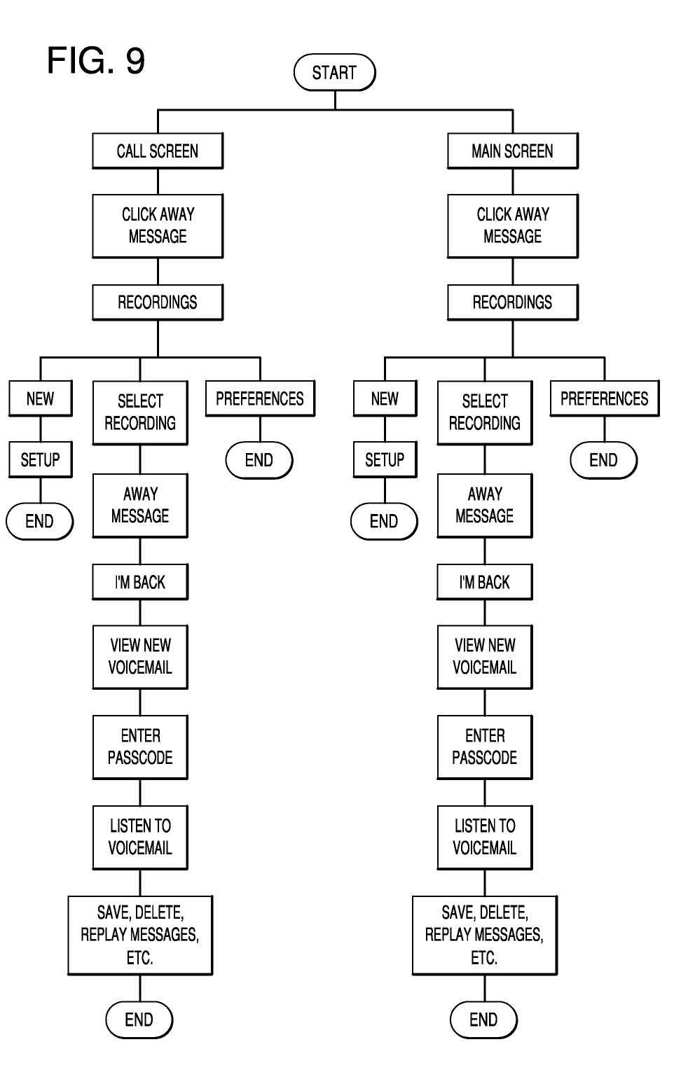

FIGS. 1-10 show specific embodiments of the present invention. It is to be understood that such embodiments are merely illustrative. The embodiments can vary from one implementation to another based on various design and aesthetic considerations.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical mobile communications device, network, system, and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

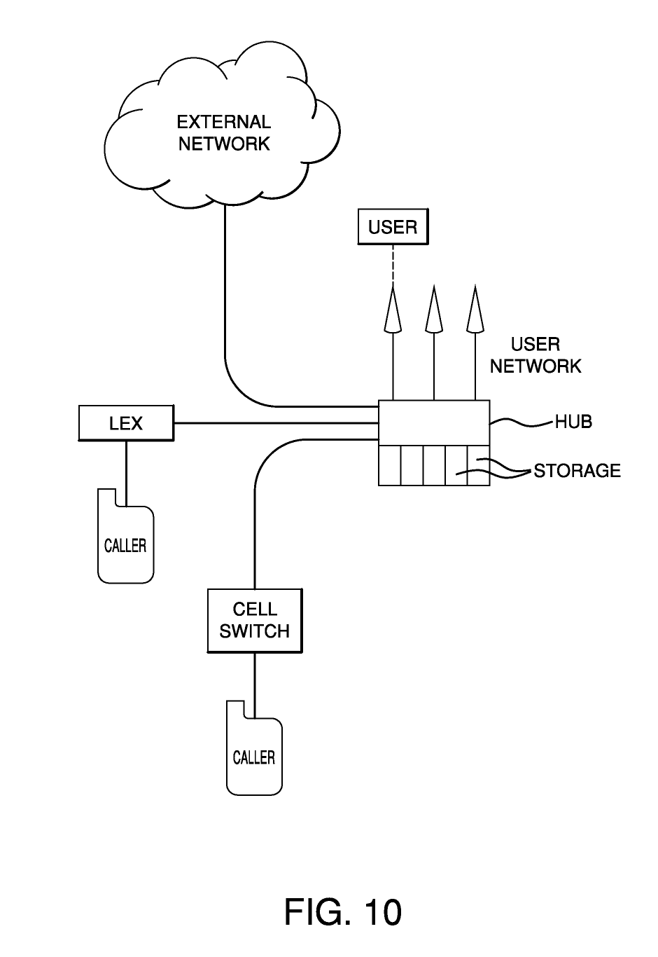

The present invention provides, within a typical cellular telephone network, and as illustrated in FIG. 10, a multi-option, hub-based voice messaging system. In a typical embodiment, the user possesses a cellular telephone, and a calling party attempts to call the user's cellular telephone. As will be apparent to those skilled in the art, when the calling party attempts the call, the call is directed via cellular switches (if the calling party is calling from a cellular phone), or local exchange switches (if the calling party is calling from a land line), to the network in which the user's cellular telephone resides. The call ultimately reaches a “hub” for communications on the called network, which may be any type of communication hub used for cellular communications as will be apparent to those of ordinary skill in the art, and the network hub may then attempt a “lookup” of the user that is being called. The lookup typically directs the call to one or more base station towers that were most recently previously in use by the user that is being called. In the event that the user is not located, alternative lookup methodologies may be available to endeavor to find the user so that the user may receive the call. However, if the user's phone is in the off position, the user will be unable to receive the call, and the call will “park” at the communication hub.

It is while parked at the communication hub that, in prior art embodiments, a voice message may have been previously recorded by the user, and it is while parked that this voice message alone may play to the calling party in the event that the cellular phone of the user is not available to pick up the call. However, in the present invention as illustrated in FIG. 10, there is provided at the communication hub an interface that makes available multiple storage locations to each cellular telephone user on the given network. In each of these locations the user may store one or more different voice mail messages, automated (i.e., computerized voice) voice messages, text messages, selected text messages from automatically generated options, graphical messages, data messages, or the like. Further, the interface referenced may make available to the user a graphical user interface with which the user may interact on the user's telephone for selection of one of the multiple messages. The graphical user interface may or may not be a thin client interface.

For example, FIGS. 1 through 9 illustrate a cellular telephone interacting, over the network and using its graphical interface, with the communication hub. As illustrated, the interface may allow for the user to interact and select to record one or more voicemail messages, enter one or more text messages, download one or more data or graphical messages, or the like. The user may then interact, based on each outgoing message that the user enters for play to a calling party, to provide a set of rules that will govern the play of the outgoing messages to the calling party. The rules may be based on, for example, the status of the user during the receipt of a call, the status, type, or identification of the calling party during receipt of the call, or the status of network communications during the attempted call.

In addition, multiple rules may be entered as a rules hierarchy for each type of available outgoing message. For example, a particular message may be selected by the user for presentation to a calling party in an instance wherein the network is generally available and the user is in a strong signal area, but the user is in a business meeting, and the user may emerge from the meeting in two hours or less, and the calling party is a client of the user not then in the meeting with the user. In such a case, the network functionality may be assessed by the network in the event a call is attempted to the user, and the user may have entered the other referenced information to the graphical interface just before the user entered the meeting that the user would be in for approximately one and one-half hours with Client A. Thus, when Client B calls the user and is identified, such as based on the user's identified callers as entered to the user's phone contacts at the telephone or via the graphical user interface, the communication hub will apply the above-referenced rules and will direct Client B's call to the specified outgoing message that the user desired be played to Client B, or any client other than Client A, during the user's less than two hour meeting with Client A.

It will be apparent to those of ordinary skill in the art that network rules may include the phone being on or off, the network being up or not, and the signal strength of the user, among others. The user rules may embody a user status of offline, online, physically, in a particular mode of transportation such as a car, a train, a plane, or other, busy or not busy, and in the event the user is busy the reason why the user is busy, the user's geographic location, the user's current activity, or the like. The calling party rules may embody a status of, for example, the caller id number of the calling party, the location from which the calling party is calling, the calling party's assigned name per the user's contacts, the calling party's home network or calling plan, or the like.

Thus, the user may create and/or follow rules via the graphical user interface, wherein the selected rule(s) are stored at the communication hub for application by the communication hub. The user may “mix and match” any of the variety of statuses using the rules to result in the playing of particular outgoing messages to the calling party.

It will be apparent to those of ordinary skill in the art that “messages” or “outgoing messages” as referenced herein may include outgoing voicemail messages, text messages, graphical or data messages, or the like.

Those of ordinary skill in the art will recognize that many modifications and variations of the present invention may be implemented. The foregoing description and claims are intended to cover all such modifications and variations, and the equivalents thereof.

We claim:

1. A voice messaging system, comprising:
a mobile communications device;
at least one communications hub communicatively connected, via one or more cellular base stations, to said mobile communications device;
at least one multi-message system resident at said communications hub, wherein said at least one multi-message system comprises a plurality of storage locations corresponded to ones of said mobile communication device; and
at least one graphical user interface at least partially resident at said mobile communication device, wherein a plurality of responsive messages corresponded to a plurality of available message rules are selectable by a user of the graphical user interface for communication to said at least one multi-message system for entry into ones of the plurality of storage locations;
wherein one of the plurality of responsive messages is playable from said communications hub to a caller calling said mobile communication device when communication with the user is unavailable.

2. The voice messaging system of claim 1, further comprising a plurality of cellular switches that route the call to said communications hub solely when the user is unavailable.

3. The voice messaging system of claim 1, wherein said storage locations comprise a particular number of memory locations corresponded to a single user.

4. The voice messaging system of claim 3, wherein each of said storage locations comprises a unique message corresponded to an unavailable one of the single user.

5. The voice messaging system of claim 4, wherein each of the unique messages comprises one selected from the group consisting of a voicemail message, a text messages, a data message and a graphical message.

6. The voice messaging system of claim 1, wherein said graphical user interface comprises a thin client interface.

7. The voice messaging system of claim 1, wherein the communications hub comprises a set of rules that govern play of ones of the messages.

8. The voice messaging system of claim 7, wherein the rules are based on the status of the user at receipt of a call.

9. The voice messaging system of claim 8, wherein the status comprises at least one of a status, type, or identification of a calling party.

10. The voice messaging system of claim 8, wherein said rules comprise a rules hierarchy.
